(19) United States
(12) Patent Application Publication
(10) Pub. No.: US 2012/0034137 A1
(43) Pub. Date: Feb. 9, 2012

(54) PLASMA REACTOR

(75) Inventor: Philip John Risby, Norwich Norfolk (GB)

(73) Assignee: GASPLAS AS, Kjeller (NO)

(21) Appl. No.: 13/202,460

(22) PCT Filed: Feb. 19, 2010
(86) PCT No.: PCT/GB10/50286

§ 371 Date: Oct. 25, 2011

(30) Foreign Application Priority Data
Feb. 19, 2009 (GB) 0902784.8

(51) Int. Cl. B01J 19/08

(52) U.S. Cl. 422/186.29

(57) ABSTRACT

A reaction vessel has a reaction chamber; and one or more plasma sources coupled to the reaction chamber. Each plasma source has a plasma generator in fluid communication with a reaction region within the reaction chamber whereby the plasma generator at least partly ionises material to form a plasma prior to entry of the at least partly ionised material into the reaction region. The reaction vessel further includes a flow inducer for establishing a fluid flow within the reaction chamber. The flow inducer has the coupling of the one or more plasma sources to the reaction chamber. The coupling induces the flow of the at least partly ionised material from the plasma generator to establish a fluid flow within the reaction chamber. The flow of the at least partly ionised material from the plasma generator is a vortex.

This invention relates to the field of plasma reactors. In particular, but not exclusively, this invention relates to a plasma reactor that may be used for the processing of a wide variety of feed materials at commercial scales.

With the current focus on reducing harmful emissions from cars and other vehicles and buildings there has been much research into developing vehicles that are fuelled by alternatives to petrol and oil such as hydrogen and biogas. Whilst the adoption of alternatives to hydrocarbon fuels offers the opportunity for a more environmentally-friendly vehicle, the process by which such alternative fuels are produced remains far from ideal.

Hydrogen for example is currently synthesised by the catalytic cracking of hydrocarbon molecules. The high temperatures required for this reaction to take place are achieved usually by burning oil or coal, resulting in the emission of further environmental pollutants. In fact, current commercial hydrogen production processes are considered to generate a higher volume of harmful greenhouse gases per useful energy quota of hydrogen than direct combustion of the fuel that the hydrogen is intended to replace. In other words, currently hydrogen is not a clean fuel when its production is taken into account.

Therefore, there is a need to develop a process capable of producing hydrogen with high efficiency and significantly lower environmental impact than is currently available. Ideally such a process would be highly flexible in that it should readily admit to operation on small, medium and large commercial scale. One method that offers the potential to generate hydrogen at lower environmental costs than existing commercial systems utilises plasma processing. In plasma processing, gases or liquids are input to a chamber in which they are ionised to form a plasma, for example by exposure to a high intensity field. In the plasma state the constituents of the feed material are dissociated and may either be extracted separately, recombined or reacted with additional feed materials, depending on the required output product. Plasma processing also offers significant advantages and unique capabilities in, for example, the areas of cracking, dissociation and deposition (including diamond deposition and fabrication of activated products) as well as gas polishing.

Various forms of plasma are known to exist, generally categorised by their energy characteristics: principally thermal plasmas and non-equilibrium plasmas. This latter group include those produced by RF, induction, barrier discharge, microwave and laser excitation. Electromagnetic-induced plasmas, in particular, offer the potential for highly efficient cracking of both gas and liquid feed materials. Such plasmas have been shown to have a catalytic effect, as a result of coupling between the electromagnetic, particularly microwave, field and the feed material, that increases the rate of reaction, which in turn reduces the time for which the feed material must be maintained in the plasma state.

In order to generate an increased volume of plasma for more efficient processing it is necessary to combine multiple generators. AC, RF and HF plasma generators have all been phase locked in order to ensure that their electric fields add in phase to increase intensity and thereby to increase the volume of plasma that can be generated. Phase-locking of microwave-generated plasmas is more complex and, to date, can only practically be achieved with very few sources, under very limited conditions and with considerable complexity. One consequence of phase-locking is that the need to couple electromagnetic generating fields into a resonant cavity means that plasma generation and reaction both take place within the same chamber. This limits the flexibility and adaptabilty of a plasma reactor to facilitate different processes.

One example of a device for the production of a microwave plasma is described in U.S. Pat. No. 6,204,603. This device makes use of a coaxial resonator into which microwaves are coupled. An electromagnetic standing-wave pattern is established in the resonator, which, at regions of high-intensity (amplitude), is sufficient to generate the plasma. Not only does the use of a resonant chamber in this device limit the potential volume of plasma that can be generated at one time but the standing wave requirement restricts plasma generation and recombination to the same physical environment.

A large area plasma generator is described in JP2006/156100. This document describes the use of a number of individual microwave antennas to generate plasma within a common space in order to achieve a more uniform distribution of plasma within that space. Although the antennas are separate, they are driven by a single, common microwave source to ensure all of the plasma sources (antennas) are in phase, thereby also limiting the maximum plasma volume. The document clearly illustrates the difficulties and complexities involved in maintaining a plasma region using multiple microwave plasma sources.

It is an object of this invention to provide an alternative device for facilitating a reaction mediated by a plasma.

It is a further object of the present invention to provide a plasma device for facilitating a reaction within a reaction chamber involving particulates and a plasma.

It is a further object of the present invention to provide a plasma device for facilitating a reaction mediated by the plasma which is capable of being operated continuously, without the need to interrupt the plasma generation process in order to generate or to remove reactant products.

Accordingly, the present invention provides a reaction vessel comprising a reaction chamber and one or more plasma sources coupled thereto, each plasma source comprising a plasma generator in fluid communication with a reaction region within the reaction chamber whereby the plasma generator at least partly ionises material to form a plasma prior to entry of the at least partly ionised material into the reaction region and wherein the reaction vessel further includes a flow inducer for establishing a fluid flow within the reaction chamber.

The flow inducer may comprise the coupling of the one or more plasma sources to the reaction chamber, the coupling being adapted for inducing the flow of the at least partly ionised material from the plasma generator to establish a fluid flow within the reaction chamber. The flow inducer may alternatively or additionally comprise flow management means coupled to at least one of the plasma sources for inducing a flow of material past the plasma generator and establishes a fluid flow within the reaction chamber.

The flow inducer may be positioned before and/or after the plasma-generating zone. Ideally, the adaptation to encourage stabilising flow is located near the plasma-generating zone. This ensures that the stabilising flow is induced prior to plasma generation, which ensures better mixing of the feed materials in the plasma, which in turn ensures better processing.

The stabilising fluid flow is most preferably a vortex flow, by which it is meant that the gases undergo a generally helical flow, of decreasing radius. It is known that vortex flow can stabilise a plasma to some degree, but it has not hitherto been appreciated that such stabilising mechanism can have the surprising benefits of flexibility in the design of reaction vessels, as described herein.

In an alternative embodiment the flow inducer is separate from the one or more plasma sources and may comprise an agitating element within the reaction chamber or a pressure management device for establishing a differential pressure between the one or more plasma sources and the reaction chamber.

In a particularly preferred embodiment of the reaction vessel, the reaction chamber includes a port for admitting particulate material independently of the plasma sources wherein the fluid flow within the reaction chamber holds the particulate material within the reaction region in suspension.

With this embodiment the reaction product may be a solid material and most preferably a solid, particulate material.

In a further particularly preferred embodiment of the reaction vessel the reaction chamber includes at least one outlet separated spatially from the plasma-generating zone, the at least one outlet and the fluid flow in the reaction chamber being arranged so as to enable removal of a reaction product from the reaction chamber without interrupting plasma generation.

In the above preferred embodiments the reaction chamber may be spatially-separate from and preferably electromagnetically isolated from the one or more plasma generators. A device constructed in accordance with the above is considerably more flexible than plasma reactors known in the prior art. The same reactor can be readily adapted to suit different processes. New reaction processes may be performed involving the use of particulate reagents and/or catalysts. With a further preferred embodiment of the present invention higher volumes of plasma may be generated and collected simultaneously without the need for phase-locking.

A plasma-mediated process comprises two distinct stages. First is the dissociation stage in which feed materials are ionised to form the plasma. The stage is very quick, typically taking only microseconds in an intense plasma. The second stage is the recombination stage in which close control of the process conditions often needs to be exercised in order to produce the required results. By making use of a chamber, remote from the one or more plasma-generating sources and thus isolated from the local environment required for plasma generation, ideal conditions can be set within this reaction chamber for recombination, with minimal effect on the conditions at the plasma-generating site. In particular, one or more ports may be included in the reaction chamber and reaction products may be extracted without stopping or interfering with plasma generation. That is, without affecting the continuous running of the process. Product removal is desirable to prevent it clogging up the system (for example, in a carbon-generation process) or to release a build-up of pressure (for example in a hydrogen or other gas-production process).

The flow of material from the plasma source to the reaction zone preferably includes a fluid, more preferably a gas. Furthermore, the flow through the plasma-generating zone of the plasma source preferentially contains one or more reactants. Depending upon the reaction process, preferably a major part, or ideally all, of at least one of the reactants flows through the plasma-generating zone. The reactants may constitute more than 50% of the flow through the plasma-generating zone, more preferably more than 75% of the flow and most preferably more than 90% of the flow.

Furthermore, encouraging a stabilising fluid flow within the reaction chamber is beneficial to the recombination process. This stabilisation may be achieved by the arrangement of the fluid flow into the reaction chamber. Where the plasma source is in the form of a nozzle having a feed tube connected to an inlet of the reaction chamber, the feed tube may be coupled to the chamber so as to input feed materials and/or plasma to the chamber at an angle to the chamber walls, preferably a tangential angle.

The stabilising flow within the reaction chamber may be a vortex flow and, in particular, the stabilising flow may assist in sustaining the plasma within the reaction chamber and/or may be capable of supporting a belt of fine particles in suspension within the chamber.

The particles to form the particulate suspension may be admitted into the reaction chamber via a port in the reaction chamber. Preferably, the port corresponds to an inlet for a plasma source. The particles may be admitted to the plasma source upstream or downstream of the plasma-generating zone, and from there flow into the reaction chamber. Alternatively, the port may be separate from the plasma sources for direct entry of the particulate material into the chamber. Passing the particulate material near to the plasma-generating zone allows the surface of the particulate material to be activated. If the entry of the particulate material is upstream of the plasma generation zone then more effective activation occurs, but at a cost of absorbing some of the energy that could be used for plasma generation. Entry downstream still allows activation by means of unreacted plasma and so does not detract from the generation process.

Ideally, the flow rate of particulate material into the reaction chamber is balanced with the rate at which particulate material is extracted from the suspension. Particles may be removed from the suspension in a variety of ways. For example, the particles may increase in mass as they act as a substrate or absorbant for a reaction product. This may result in the flow rate becoming insufficient to support the increased mass and the particles drop out of the suspension under gravity. Alternatively, the particles may be directed by the flow towards an outlet where they are extracted.

The fluid flow within the reaction chamber enables delineation of a “reaction region” within the chamber within which the majority of the required reactions take place. Ideally, the plasma generated in accordance with this invention is induced to flow in a stabilising pattern, which extends the existence of the plasma beyond the immediate plasma-generating site enabling transportation of the plasma into the reaction region. Predominantly, it is the plasma afterglow that persists in the reaction chamber, the afterglow being that region in which plasma is sustained by mechanisms other than the generating excitation. Such persistence is believed to be assisted by the stabilising flow.

Preferably, the reaction chamber has curved side walls. For example, the chamber may be cylindrical, toroidal or even spherical in shape. This shape assists in establishing a stabilising flow within the chamber. In combination, this arrangement offers great potential for improvement to a huge range of chemical and physical processes. In the first instance, the plasma plumes/afterglow will extend from the plasma sources into the reaction chamber and be shaped by the flow pattern to extend laterally alongside the reaction chamber wall. This extended plasma region essentially defines the “reaction region” referred to above. Feed or other reactant materials that flow around the chamber will then experience an increased residency time in an afterglow environment, as the afterglow from successive nozzles is encountered. This allows more complete plasma processing and therefore improved reaction efficiency. If the plasma sources are sufficiently close and/or the plumes persist for sufficient time, these individual plumes may merge to form a continuous plasma torus within the chamber.

Whilst the volume of the reactor chamber in each case will be dependent upon the intended application and the processing requirements of the plasma reactor, when a 2.45 GHz microwave plasma generator is used as the plasma source exemplary ranges of volumes are 10⁻³ m³ to 10³ m³, more preferably 10⁻² m³ to 10² m³, most preferably 1.5 m³ to 10² m³. The volume of the reaction chamber should be no less than 5×10⁻⁴ m³ per nozzle per KW but may extend upwards from this without limitation.

The residency time within the reaction chamber is dependent upon the reaction(s) occurring within the chamber and the desired output product but may extend from 0.1 seconds to several hours.

Conditions may be controlled within the reaction region to offer huge flexibility in supporting a range of chemical and physical processes. The chemistry and kinetics of the reaction region can be controlled in complex ways via adaptation of flow rates, plasma source sizes and direction. Additional inputs may be used to bring further reaction materials, buffer materials or catalysts into the mix either through existing inactive plasma sources or at additional injection points. Ready separation of reaction products may, in many cases, be enabled. For example, if carbon and hydrogen are the reaction products, the carbon may be allowed to cluster and drop under gravity whereas the hydrogen flow may be directed upwards. Exits at the top and bottom of the chamber therefore allow these products to be removed as the plasma sources continue plasma generation and the reaction continues in the chamber. That is, product removal is facilitated without stopping the reaction process. The potential for continuous running significantly improves productivity.

As mentioned earlier, the stabilising fluid flow that is established in the chamber may be capable of supporting a belt of particles in suspension. Such particles can have a number of effects. Firstly, the particles may act as a substrate for one or more of the reaction products. The high surface area of a large number of small particles is large, ensuring an effective target area for product deposition. For example carbon, as a reaction product, may be deposited on the particles. This causes their weight to increase to the extent that the stabilising flow is insufficient to support them and the particles with deposited carbon drop under gravity, which assists in their separation and removal from the chamber. Again, this permits continuous operation of the reaction chamber as opposed to a batch process. Secondly, the particles may provide a substrate that encourages the formation of specific product forms, for example carbon nanostructures. That is, the particulate surfaces take an active part in the formation process of the reactant product. Thirdly, the particles within the belt may act as an absorbant medium in which to capture and separate specific gas products.

Fourthly, the particles may provide a reactant with which to form an output of desired chemical composition. For example carbon, as the product of a plasma mediated reaction, when deposited on an belt of silicon particles in the reaction chamber will produce silicon carbide. Fifthly, the particles may provide an ingredient that is required for a specific process output. For example, sand or soil particles injected into the reaction chamber allow a carbon reaction product to be finely integrated and so provides more fertile growing material for crops.

The particles preferably have an average diameter of between 50 nm and 10 mm, more preferably 10 μm and 500 μm, most preferably 50 μm and 300 μm. Their preferred composition is inorganic compounds, especially the solid elements as metals and metalloids, also metal (optionally mixed) oxides and metal coated inorganic particles. Preferably the particles interact with the reactants, for example by influencing the chemical pathway or rate, by increasing the rate, by absorbing reaction products or by influencing morphology of a solid product by combining with it, e.g. by seeding a particular nanostructure formation or by seeding and increasing the particle size of its product.

The above list is given to provide an indication only of possible applications. It is not intended to be comprehensive, only to allow an appreciation of the plasma reactor's potential. As will be discussed below in relation to particular embodiments, this invention will readily find application in the fields of, among many others, manufacturing, energy production and waste treatment.

It is noted that there is no theoretical restriction on the number of plasma sources that may be coupled to the one reaction chamber. The only practical limit is that of the size of the collection chamber. For example, in the case of the plasma sources being plasma nozzles, the practical limit is based upon the physical dimensions of the coupling of a plasma nozzle to the collection chamber i.e. the number of plasma sources that can be physically fitted around the chamber. In some applications the number of plasma sources may be limited by the need to establish particular gas flow characteristics within the reaction chamber.

Where the plasma nozzles are used as the plasma sources, the fluid fed to the plasma nozzles is preferably at a temperature of between −20° C. and +600° C., more preferably 0° C. to 200° C., most preferably 50° C. to 150° C. The pressure within the plasma nozzle is preferably between 0.01 bar abs. to 5 bar abs., more preferably 0.3 bar abs. to 2 bar abs., most preferably 0.8 bar abs. to 1.5 bar abs.

The average residence time within a plasma nozzle may be 10⁻⁶ seconds to 10⁻¹ seconds, but preferably 2×10⁻⁶ seconds to 10⁻² seconds. It will be understood though that the average residence time is dependent upon the material being ionised. As an example, the specific energy consumed to completely crack methane passing through the microwave plasma generator of the present invention at 100% efficiency is around 23 kJ/mol.

The term “plasma source” should be understood herein to encompass any device that is capable of directing a plasma, and optionally other material, from a plasma-generating zone to a reaction region within the reaction chamber.

Of the known characteristics of plasmas generated by the variety of methods available, microwave-generated plasmas are most suited for chemical processing, such as cracking of feed materials. It is accordingly preferred that the plasma generators of this invention are microwave plasma generators.

Microwaves are generally taken to refer to electromagnetic radiation with a wavelength in the range 1 m to 1×10⁻² m. Electromagnetic radiation outside this range can still generate plasma effectively but microwave sources represent a mature technology as they have long been used in the fields of radar and microwave ovens. Hence microwave sources of suitable power levels are readily available. Microwave sources suitable for use with the present invention preferably operate with device wavelengths in the range 0.5 m to 0.05 m, most preferably 0.1 m to 0.3 m and are preferably coaxial magnetrons. The energy supplied to such a microwave source is preferably between 0.1 kW and 500 kW, more preferably 0.5 kW to 120 kW, most preferably 1 kW to 75 kW.

Microwave-generated plasma sources can be divided into two groups: those that operate at low pressure and those that operate at around atmospheric pressure and above. Any commercial system that can be used for fuel dissociation is preferably based on a ‘high-pressure’ system, which permits higher throughput of feed fluids and allows effective and energy-efficient storage of end products. The considerable differences in pressure that can occur in a low-pressure system make the adoption of a low-pressure system less attractive for commercial applications.

Two prior types of atmospheric plasma generator are known: low volume single tube and higher volume single magnetron. Whilst reactors based on both types have had some success on the laboratory scale, no design has yet proved sufficiently flexible for operation on a commercial scale. Those in the former group are limited in size by the dimensions of the waveguide required to contain the exciting radiation. That is, the waveguide forms at the surface of the plasma, thereby containing it. A fundamental limit in reactor tube diameter is thus set by the frequency of the microwave source, which limits application to lab-scale devices. Those in the latter group rely on a resonator cavity to generate localised regions of high-intensity electromagnetic fields, which in turn generate and sustain the plasma. High power sources are therefore required, both to generate the plasma and to supply sufficient energy to the feed material for processing. Device size is again limited by microwave source frequency and power as the reaction chamber is required to be resonant. Both microwave frequency and the power at which it is generated therefore limit the potential chamber size of a reactor based on this operational principle.

There is therefore a problem in scaling up reaction chambers that use microwave-generated plasmas for commercial operation in that microwave sources are not readily phase-locked. Thus, whilst microwave plasmas offer an ideal route to facilitating chemical reactions and processes these have, to date, only been carried out on a relatively small scale.

A preferred embodiment of the present invention which permits multiple plasma generators to output plasma into a common chamber does not rely on phase-locking. Accordingly multiple plasma generators, of whatever type, can be used with this invention. The total plasma generation input to the reaction zone can be from 1 kW to several MW depending upon the application and is a function of the number of plasma generators used. It is another facet of the flexibility of a reaction vessel in accordance with this invention that it can operate with microwave, AC, DC, RF, HF, thermal or other plasma sources. Indeed in some processes it may be advantageous to introduce plasmas to the chamber that come from a mixture of different plasma sources.

Also, the plasma reactor of the present invention is not limited by the type of plasma that is used. Each plasma source may comprise a low-volume source or a large-volume resonant source, or indeed any other suitable plasma source: it is considered beneficial, for likely commercial applications however, to operate at near-atmospheric pressure and above. A preferred operating range is 0.3-3 bar, although operating pressures up to around 10 bar can be envisaged.

With a particular preferred embodiment of the present invention the plasma source is preferably a plasma nozzle having a coaxial magnetron as a microwave plasma generating source. Each nozzle comprises a feed tube through which feed materials flow and each magnetron may comprise at least one waveguide dimensioned for microwave radiation and arranged to intersect the feed tube at or near a position at which the electric field of the microwave radiation is most intense. Such a design is simple to implement and, in fact, such microwave sources are readily and cheaply available.

The fluid passage of each nozzle is preferably straight and the nozzle diameter at the plasma-generating zone is preferably between 5 mm and 100 mm, more preferably between 10 mm and 50 mm, most preferably 30 mm to 40 mm for a 6 kW magnetron.

In the preferred embodiment the feed tube may include a swirl inducer located near the intersection of the feed tube with the magnetron waveguide. This ensures that a stabilising (preferably vortex) flow is induced prior to plasma generation, which ensures better mixing of the feed materials in the plasma, which in turn ensures better processing.

An outlet of the reaction chamber (sometimes referred to herein as the collection chamber) may comprise an exit channel that extends through an upper wall of the chamber, and which is preferably centrally located. The exit channel may extend a pre-selected or adjustable length into the chamber. The exit channel acts as a collection point for gaseous output(s) from the reaction chamber. Its height within the chamber can be set or adjusted to collect a particular gas product. Multiple exit channels may also be provided at the same or at a variety of heights. Within the exit channel a number of smaller tubes may be fitted internally in such a manner as to encourage the vortex motion to remain in the reaction chamber and not to dissipate with exhaust gas outflow.

The plasma reactor may further include a secondary chamber in fluid communication with the reaction chamber. The secondary chamber may also include an exit port. In a preferred embodiment the secondary chamber is located below the reaction chamber. Such a lower port is ideally placed for extracting solid products from the chamber. Moreover, a secondary vortex may be drawn through this exit port, oriented centrally within the chamber, in order to entrain a reaction product for collection. For example, in the cracking of methane in the presence of steam, the output products will be hydrogen and carbon monoxide (syngas). By entraining a flow of magnesium hydride through the central zone of the chamber, the hydrogen will be absorbed by the magnesium hydride for exiting at the lower port, allowing the carbon monoxide to exit as a gas via the upper exit port. In order to prevent gas escaping the lower exit port, the port may be fitted with a gas-restricting valve.

A collection aid such as an electrostatic collector, powder precipitator or polymer-forming substrate may be included within or in fluid communication with either or both of the upper and lower chambers. These provide further possible means to collect an output product depending upon the nature of the reaction taking place within the reaction chamber. For example, an electrostatic plate or ring will attract solids, encouraging their separation from a gas flow. This assists in providing for continuous operation of the reaction vessel.

A particularly promising application of the present invention is the cracking of hydrocarbons to produce hydrogen gas and carbon. The hydrogen gas can be collected via the exit channel for use as a clean fuel. The carbon can be collected in the form of active carbon.

So as to enable the introduction of substrates or other materials for product collection, the reaction chamber may further include an input channel along which a secondary flow may be passed. The secondary flow may interact with the primary flow within the chamber in order to encourage residency in the reaction zone or removal of products therefrom.

The plasma reactor may also include one or more atomising or vaporising devices to enable liquids to be processed in this invention.

The present invention separately provides a plasma nozzle suitable for use with the reaction vessel set out above, the plasma nozzle comprising a plasma generator; a feed tube for directing a flow of feed material from an inlet past a plasma-generating zone to a nozzle outlet remote from the plasma generator, the nozzle outlet being adapted for coupling to a reaction chamber; and flow management means for controlling the flow of feed material in the feed tube whereby the plasma generator at least partly ionises the feed material to form a plasma which is sustained by the flow to the nozzle outlet.

A further aspect of the present invention provides a hydrogen generating vessel comprising a supply connection adapted for connection to a supply of a gaseous hydrocarbon; one or more plasma sources coupled thereto and a reaction chamber coupled to the one or more plasma sources; each of the plasma sources having a plasma generator and being adapted for directing a flow of the hydrocarbon via the plasma generator to a reaction region within the reaction chamber whereby the plasma generator at least partly ionises the gaseous hydrocarbon to form a plasma prior to entry of the at least partly ionised hydrocarbon into the reaction region and the reaction chamber includes at least one outlet via which hydrogen is collected.

A still further aspect of the present invention provides a carbon extraction vessel comprising a supply connection adapted for connection to a supply of a gaseous hydrocarbon; one or more plasma sources coupled thereto and a reaction chamber coupled to the one or more plasma sources; each of the plasma sources having a plasma generator and being adapted for directing a flow of the hydrocarbon via the plasma generator to a reaction region within the reaction chamber whereby the plasma generator at least partly ionises the gaseous hydrocarbon to form a plasma prior to entry of the at least partly ionised hydrocarbon into the reaction region and the reaction chamber includes a particulate suspension that acts as a substrate onto which carbon is preferentially deposited.

Embodiments of the invention will now be described by way of example only and with reference to the accompanying drawings.

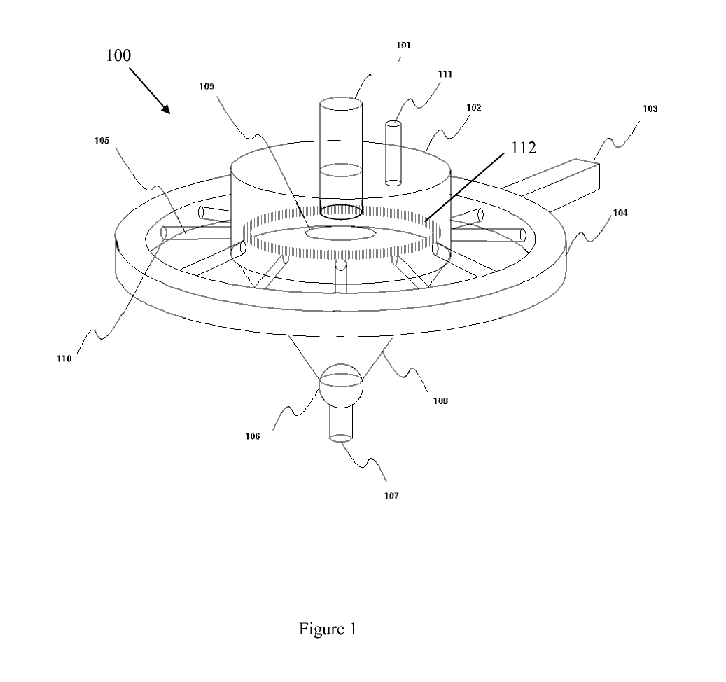

FIG. 1 is a schematic illustration of a reaction vessel in accordance with this invention.

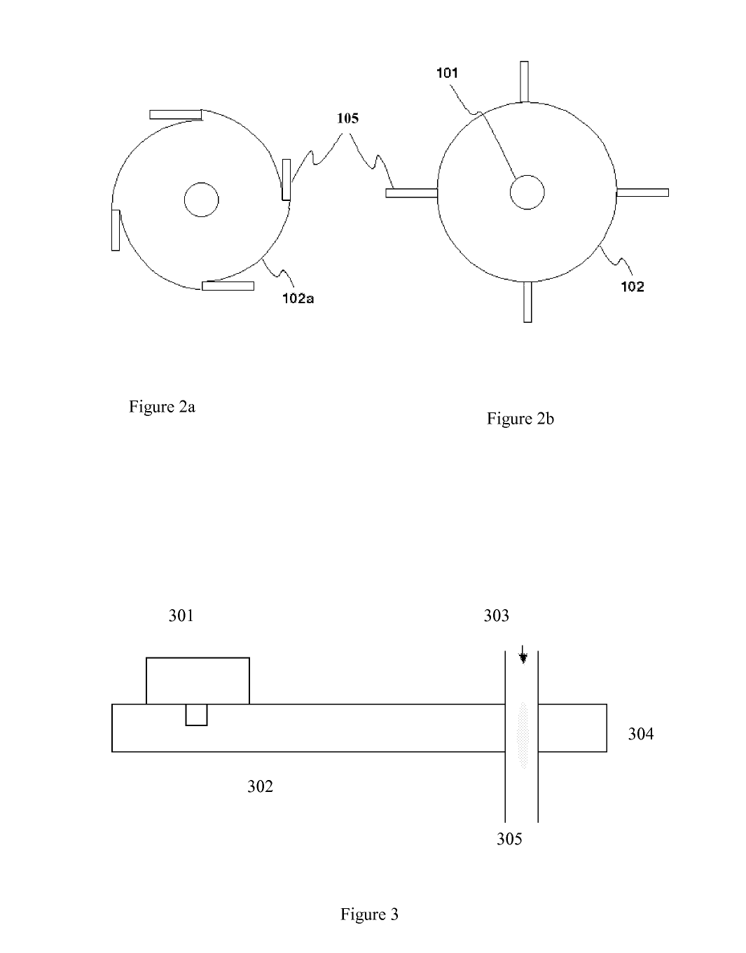

FIG. 2a is a schematic illustration of an embodiment of the invention showing an arrangement of plasma nozzles about the reaction chamber.

FIG. 2b is a schematic illustration of an alternative embodiment showing a different arrangement of plasma nozzles about the reaction chamber.

FIG. 3 illustrates schematically an example of a plasma source that is suitable for incorporation in the nozzles.

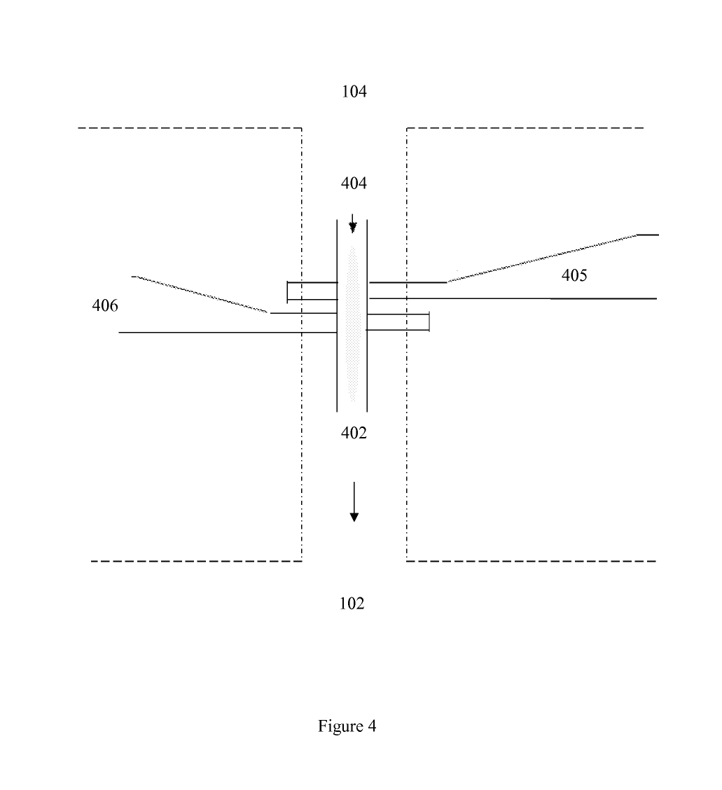

FIG. 4 illustrates schematically a second example of a plasma source that is suitable for use with this invention.

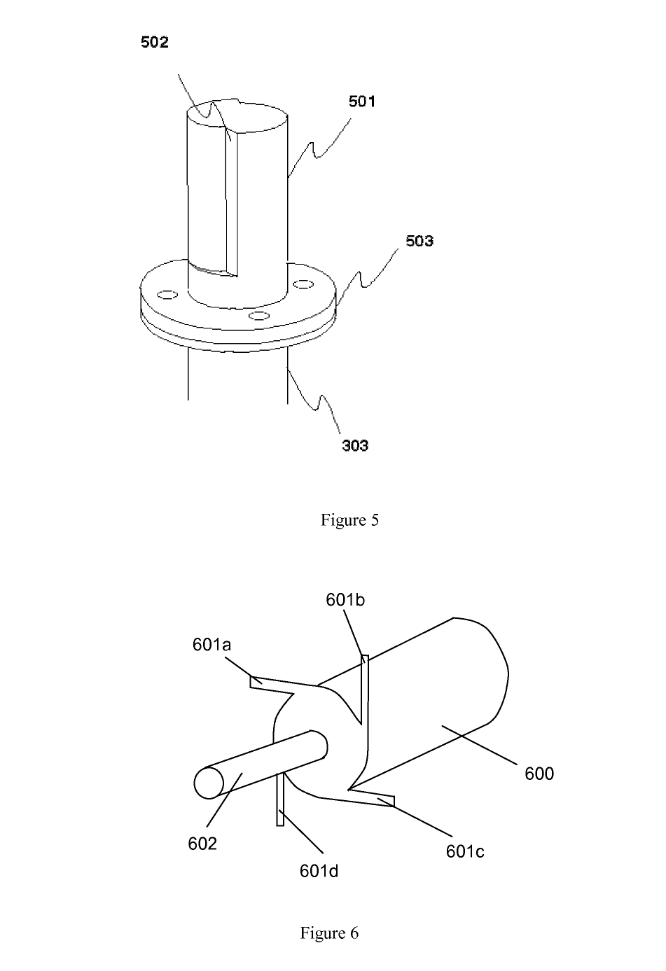

FIG. 5 is a schematic illustration of a component of the plasma nozzle shaped so as to direct feed gases in a vortex motion through the plasma-generating zone.

FIG. 6 is a schematic illustration of an alternative component within the plasma nozzle shaped so as to direct feed gases in a vortex motion through the plasma-generating zone.

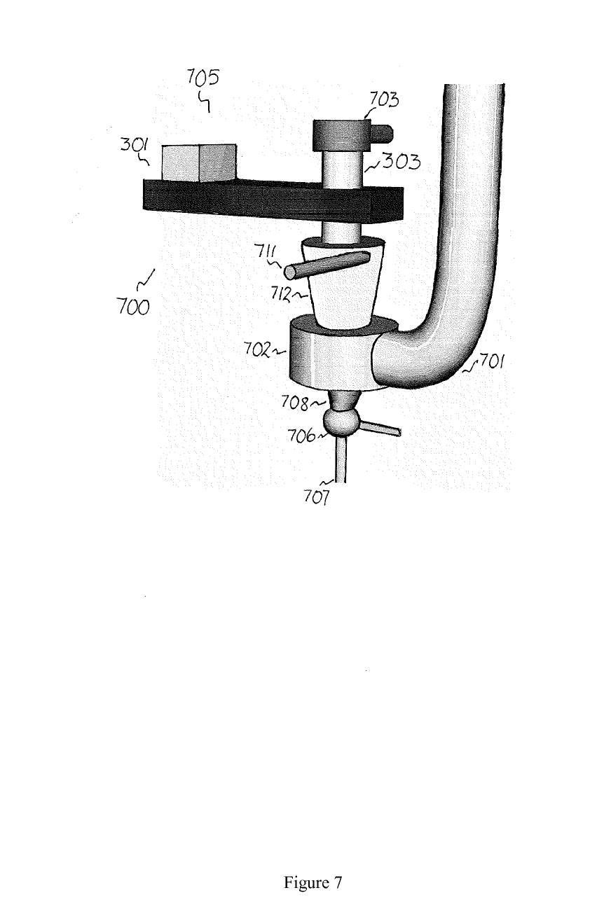

FIG. 7 is a schematic illustration of an alternative reaction vessel employing a single nozzle.

With reference to FIG. 1 there is shown, in overview, a plasma reactor 100 in accordance with the present invention. The reactor 100 comprises an input channel 103 through which feed gases flow to an annular manifold 104. A plurality of plasma nozzles 105 connects the manifold 104 to a reaction chamber 102. In one specific construction four nozzles of 35 mm diameter are used. A greater or lesser number of nozzles than the number illustrated are also envisaged, as are diameters within the range 25 mm to 50 mm. The reaction chamber 102 is 500 mm diameter. It could be, for example, in the range of 250 mm to several meters diameter, depending on the desired scale of production. Within each plasma nozzle 105 the feed gases may be excited to form a plasma at a plasma-generating zone or region. The minimum separating distance between a plasma-generating zone and the inlet to the reaction chamber is the minimum distance necessary to ensure electromagnetic isolation of the individual microwave fields of the plasma nozzles. The maximum separating distance is dependent upon the persistence of the plasma state which, in turn, is dependent upon at least the energy of the plasma, and the velocity and stabilisation of the feed flow. Preferably, the distance separating the plasma-generating zone from the reaction chamber is between 0.005 m and 1 m, more preferably between 0.05 m and 0.5 m, more preferably still between 0.02 m and 0.2 m.

Each nozzle includes a flow inducer in the form of a swirl inducer 110 which is located at the input to the nozzle or between the nozzle input and a plasma generating zone (not shown in this figure) of the nozzle. The swirl inducer 110 is adapted to encourage the feed gas to flow with a vortex motion. This vortex motion stabilises the plasma generated within the nozzle in such a way that it is sustained and remains in an ionised state as it flows from the nozzle into the reaction chamber 102. Accordingly, the plasma is reactive for some duration of its time in the reaction chamber 102. Ideally, the direction of rotation of each vortex flow within the nozzles is such that the vortex flow within the nozzle may positively contribute to the general stabilisation of the plasma within the reaction chamber.

A lower chamber 108 is located below the reaction chamber 102 and this may be used in separating reaction products. In this embodiment, it is assumed that a solid product of the reaction is separated in the lower chamber. It is desirable to establish a rotating fluid flow the plane of rotation of which is substantially horizontal to or spiraling within the reaction chamber and so the reaction chamber with the adjoining lower chamber preferably define a cyclone for the collection of solid particles. The solid product passes through a gas restricting valve 106, for example a rotary valve, to a lower output port. An upper output port 101 is provided above the chamber 102 and, in this embodiment of the invention, is used to collect gaseous reaction products, which are prevented from exiting via the lower output port 107 by virtue of the rotary valve 106. A suspended belt 112 of particulate material is shown in this Figure, the formation of which will be described in more detail below.

Operation of the plasma reactor 100 will now be described in relation to FIG. 1. A feed supply of gas to be processed enters the manifold 104 through input channel 103 at a controlled pressure, typically between 1 and 2 bar abs. The flow rate of the feed gas is adjusted in accordance with various conditions of the reaction: for example, the energy of the plasma generating source, the chemical composition of the feed gas and the desired reaction outputs. Gas flows are typically between 10 l/min to 100 l/min per nozzle for this embodiment, which uses 6 kW magnetrons for plasma generation. The feed gas then flows through the multiple plasma nozzles 105. Within each nozzle, the feed gas is agitated to a stabilizing flow pattern, such as a vortex motion, by the swirl inducer 110 and then excited to a plasma at the plasma-generating zone, which is based on 6 kW magnetrons. The result is a moving cloud of dissociated and/or partly dissociated gas, which continues in its flow pattern to the reaction chamber 102. The flow pattern of the plasma increases the stability of the plasma in the sense that the gases are maintained in the plasma state after the plasma-generating zone and into the reaction chamber 102. Such stabilisation allows the ionised gases to remain concentrated both after the plasma source and within the reaction chamber, thereby extending the active region in which reactions can take place. In the reaction chamber 102, the constituents of the dissociated gas may be separated or may be recombined to form other products, or may react with a substrate 112 or other substance introduced to the chamber 102, depending on the specifics of the required reaction. Whichever reaction route is used, the products are extracted through output ports 101, 107.

The magnetrons in the embodiment described above are 6 kW magnetrons, but alternative magnetron sources of up to 100 kW or even greater still, depending upon availability, could be used. Higher fluid flow rates through the nozzles and in the chamber will be preferred for higher power magnetrons.

A test of the principle underlying the present invention was performed using three microwave plasma nozzles each connected radially to a common 0.5 m diameter reaction chamber and spaced 90° from one another at their intersection with the reaction chamber. Each plasma nozzle comprised a 1.5 kW microwave source which intersected a quartz tube having an internal diameter of 32 mm. The plasma-generating zone of each plasma nozzle was located 0.15 m from the reactor chamber. A buffer gas (nitrogen) was introduced into all three plasma nozzles simultaneously and was introduced into the nozzles tangentially thus generating a stabilising swirling gas flow in each of the nozzles. In each of the nozzles the nitrogen was ionised at the plasma-generating zone. The plasma and its afterglow was then observed to extend from the point of generation along the quartz tube and into the reaction chamber.

Separating the plasma generating regions from the reaction chamber has a two-fold effect. First, the plasma output from the nozzles is additive. That is, each nozzle feeds its plasma into the chamber and the volume of plasma in the chamber is multiplied in proportion to the number of nozzles used. Secondly, the reaction chamber is not limited in any way by the method with which plasma is generated, specifically the wavelength of microwaves, where microwaves are used to generate the plasma. This, in turn, means that the design of the plasma reactor is hugely flexible enabling it to be readily adapted to the reaction that is taking place within. For example, a substrate can be introduced to the chamber or gas flow can be used to entrain specific products.

In the embodiment shown in FIG. 1, finely-powdered particles of a seed, substrate or other material to be involved in the reaction are introduced to the chamber 102. Flow conditions around the chamber are such that these particles are supported inside of the reaction region in the form of a moving or dynamic belt 112. Formation of such a belt within a plasma reaction chamber is not known in the prior art. It confers flexibility to the reaction process. Belt material can be continuously extracted, and/or processed and replenished through direction of fluid flow. New materials can be added at different stages of the reaction process, enabling different products to be captured and removed. A mix of materials can be included in order to withdraw two or more products.

The particles to form the belt may be introduced through one or more plasma nozzles that are inactive (i.e. not involved in the plasma generation). The particles can be introduced through an entry port in either active or inactive nozzles located just after the plasma generator. In some situations, in which activation of the particle surface by the plasma-generating field is beneficial, the particles may be introduced to the nozzle with the feed material. Alternatively, one or more separate input ports 111 may be used.

The particles introduced into the reactor chamber preferably have an average diameter of between 50 nm and 5 mm, more preferably 10 μm and 500 μm, most preferably 50 μm and 300 μm. Their preferred composition is inorganic compounds, especially the solid elements as metals and metalloids, also metal (optionally mixed) oxides and metal coated inorganic particles. Preferably the particles interact with the formation of the reactants, especially by influencing the chemical pathway or rate, especially increasing the rate, absorbing reaction products or influencing morphology of a solid product by combining with it, e.g. by seeding a particular nanostructure formation or by seeding and increasing the particle size of its product.

In other operational modes, different feed materials can be introduced into various of the plasma nozzles around the reaction chamber. This enables the chamber conditions to be set to enable more complex reactions to take place.

The above dimensions and values of parameters used for the reaction vessel are illustrative of one particular embodiment only and are not intended to be limiting. The system described is readily scaled-up. For example, the 6 kW magnetrons operating at 2450 MHz could be replaced by 1 kW to 30 kW magnetrons. Still larger magnetrons that are available of between 35 kW and 100 kW, operating at lower frequency, may be used with larger, upwards of 100 mm diameter, nozzles. The reaction chamber should be scaled up in size in proportion and according to the number of nozzles fitted.

Stabilisation of the plasma is an important feature of the separation as it enables the reactive phase of the feed gas to be maintained in the reaction chamber 102, remote from the plasma-generating zone. A vortex motion, which is simply motion of the fluid in a roughly helical pattern, is known to form a relatively stable flow structure. This structure can be readily drawn through the plasma-generating zone of the nozzles and the helical motion ensures an even distribution of feed gas exposed to the exciting source. The vortex should persist until such time as the plasma is comfortably within the chamber 102. Obviously the actual time will depend on factors such as vortex velocity and initial gas flow.

In considering stabilisation it is necessary to take account of the balance to be struck between fuelling the reaction that is taking place and forming the plasma. Increasing the flow through the plasma-generating region of the nozzles will transfer plasma faster and this in turn should reduce the need for vortex stabilisation. However, increased flow means increased energy demand on the plasma source in providing energy for the ionisation, in order to avoid reducing the plasma density.

Alternative flow inducers and stabilisation methods are possible of course, although the vortex flow is preferred. It is simply required that an external force is applied to the flow in order to hold the plasma “cloud” in a particular shape, which is maintained as the plasma flows into the reaction chamber 102. For example a magnetic force may be used or a sonic flow.

Within the reaction chamber, the plasma cloud extends from the nozzles and then adjacent the chamber wall. This results in extended regions of plasma, spaced alongside the wall, through which feed and other reactant materials flow. This increases residency time of the reactant materials in the plasma cloud(s) or reaction region(s) and so improves process completion and efficiency. Spacing between the nozzles around the chamber determines the shape and intensity of the plasma cloud(s) within the chamber. In particular, each cloud may merge with its neighbours to produce a continuous toroidal plasma zone located adjacent the wall of the reaction chamber.

In order to illustrate the flexibility of this invention, two specific reactions will be considered. The first reaction is the dissociation of methane to produce hydrogen and carbon. Methane is fed in to the manifold 104 and through the nozzles 105 to enter the reaction chamber 102 as a plasma. From the point that the plasma is generated, the reaction within the plasma to form dissociated carbon and hydrogen begins and continues within the reaction chamber 102. Hydrogen gas is collected through the upper output port 101.

In one embodiment, an electrostatic plate or ring is placed in the lower chamber 108. The solid carbon produced by this reaction is attracted to this plate or ring, on which it is accordingly deposited preferentially. The ring can be removed and replaced, as necessary.

In a preferred embodiment, carbon particles are injected into the reaction chamber through an inlet port 111 to act as seed particles. Flow conditions within the chamber act on the carbon particles to suspend them in a belt extending around the chamber. For example a flow rate of 20 l/min through each of 4 nozzles oriented at 45° to the chamber radial direction is sufficient to support a density of 0.1 g/cm³ seed particles in the range 50-100 μm diameter flowing at a rate of 10 l/min total volume of particles. The rate at which seed particles are fed into the suspension should match the rate at which they are removed by some process within the chamber. The carbon produced by the dissociation of methane is deposited on the seed particles. As the mass of the seed particles increases, they drop under gravity from the belt and the resultant fine carbon clusters can be extracted at the base of the chamber. The belt is dynamic both in that it is in continuous flow around the chamber and in that as the carbon clusters drop, new seed particles are injected at a set flow rate (10 l/m in the example given herein). In the latter case the belt is constantly being replenished. This enables improved separation of carbon from the output hydrogen flow, in relation to the prior art and also enables continuous operation.

Seed particles can be either externally sourced or extracted from the reaction itself. Output hydrogen will, under normal operating conditions, entrain a small amount of fine carbon particles. The output gas is therefore filtered to extract any carbon, which can then be fed back into the chamber as seed material. As the carbon clusters to the seed, these larger particles may be separated by another stage of this filter.

In a third alternative, inorganic oxide spheres of similar size and density to the carbon example given above are injected into the chamber to form the suspended belt 112. The structure of the oxide spheres is such as to encourage growth of carbon multi-walled nanostructures. As is well known in the art of nanostructures, other shapes and substrate materials may be used to encourage other growth structures.

The hydrogen can be used as a fuel and the carbon is readily formed into products such as active carbon or carbon black. These carbon products are advantageous in comparison with currently available commercial products in that they are free from sulphur and oxygen impurities.

Alternatively, a combination of methane and water can be fed into the manifold. In this embodiment, vaporising or steam injection jets are included in the manifold 104 in order to convert the water to gaseous form. The reaction product in this instance is syngas (carbon monoxide and hydrogen). Syngas separation has, in the prior art, proved difficult to achieve. In this embodiment of the invention however, magnesium hydride can be introduced to the lower chamber 108, or as fine particles in a vortex gas flow that extends centrally within the chamber 102 and is drawn though the upper output port 101. The magnesium may be input as fine particles to form the suspended belt 112. The magnesium hydride will absorb hydrogen, leaving the carbon monoxide to be collected out of an additional exit.

With reference now to FIGS. 2a and 2b, alternative orientations of plasma nozzles 105 with respect to the reaction chamber 102 are shown. In FIG. 2a, the arrangement shown is a multiple-start spiral formation 102a. The vortex flow developed within the nozzle is, in this formation 102a, further encouraged in the reaction chamber 102. This can be beneficial for some processes. The alternative arrangement shown in FIG. 2b provides a more axial flow in the reaction chamber 102. This is better suited for syngas formation as opposed to solid carbon formation, using the examples outlined above. It will be understood by one skilled in the art that nozzle configurations between these two extremes form a range of embodiments.

By virtue of the nozzle arrangement, or otherwise, fluid flow within the reaction chamber may be maintained. Under certain circumstances this flow may be sufficient to support a suspended belt of introduced particles, which may act as a substrate for one or more of the reaction products.

The reaction chamber 102 illustrated in this embodiment is toroidal in shape but it can alternatively be in the form of a sphere or cylinder, or other shape, preferably with curved walls.

In the examples of FIGS. 2a and 2b, four plasma nozzles 105 are shown feeding into the reaction chamber 102, but this is for clarity of illustration only. Many more nozzles can be used, the limiting factor essentially being how many can be fitted around the chamber 102. It is also, of course, not essential for all nozzles to be used in generating plasma. For example, in a chamber with ten nozzles, perhaps only five may be used for plasma generation for one particular reaction. The remainder would be closed in order to prevent feed gases bypassing the plasma-generating zones of the active nozzles and entering the chamber. Alternatively nozzles not being used for plasma generation may be used to inject substrate particles or to inject gases (including gases from the output of the reaction chamber) thereby to supply reactants and/or to increase the kinetic energy within the reaction chamber.

As noted above, separation of the plasma generation from the reaction chamber is an important feature as it permits the nozzles to make an additive contribution to plasma generation. Accordingly, the structure of these nozzles will now be described more fully with reference to FIGS. 3 to 6. FIGS. 3 and 4 illustrate possible arrangements for the plasma-generating zone, both based on microwave plasma generation. FIGS. 4 and 5 illustrate examples of the swirl inducers 110.

Turning first to FIG. 3, there is shown a magnetron 301 and waveguide 302 configured as a plasma generator. The magnetron 301 is a conventional microwave generator structure, generally found in microwave ovens. In this arrangement a 1 kW magnetron 301 feeds into a standard waveguide 302 with a closed end 304 forming a quarter wave stub. A quartz tube 303 is located at a point where the E-field is a maximum i.e. one quarter wavelength back from the closed end 304 such that the E-field intensity causes gas contained in the tube 303 to become ionised. Gas to be processed is fed into the tube 303 and flows from the intersection of the tube 303 with the waveguide 302 to an exit 305 in a dissociated state. An example of a suitable waveguide is the Surfaguide™ supplied by Sairem. The quartz tube 303 may equally be of another material that is electrically insulating and with a low dielectric constant at the preferred frequency of operation.

It is not, of course, essential to use microwave-generated plasma with this invention, but the ready availability of microwave sources and the fact that microwaves generate highly effective processing plasmas renders them attractive. The usual drawback of commercially available sources, namely that they are low power, is overcome in this invention as the individual outputs from each plasma generator are added together. For example, the largest commercially available magnetrons are in the range 75-120 kW. Using a number of such magnetrons, say 10, oriented around a reaction chamber, a plasma zone of MW intensity can be generated.

The fluid passage of each nozzle is preferably straight and the nozzle diameter at the plasma-generating zone is preferably between 5 mm and 100 mm, more preferably between 10 mm and 50 mm, most preferably 30 mm to 40 mm for a 6 kW magnetron.

The microwave plasma generator employed in the plasma nozzle is preferably a coaxial magnetron. Furthermore, the microwaves generated and used in the plasma nozzles preferably have a device wavelength at between 0.01 m and 2 m, more preferably 0.05 m to 1.5 m, most preferably 0.1 m to 0.3 m. Also, the energy supplied to the microwave generator of each plasma nozzle is preferably between 0.1 kW and 500 kW, more preferably 0.5 kW to 120 kW, most preferably 1 kW to 75 kW.

The flow of material through the plasma nozzle preferably includes a fluid, more preferably a gas. Furthermore, the flow through the plasma-generating zone of the plasma nozzle preferentially contains one or more reactants. Preferably, a major part, or ideally all, of at least one of the reactants flows through the plasma-generating zone. The reactants may constitute more than 50% of the flow through the plasma-generating zone, more preferably more than 75% of the flow and most preferably more than 90% of the flow.

The fluid fed to the plasma nozzle is preferably at a temperature of between −20° C. and +600° C., more preferably 0° C. to 200° C., most preferably 50° C. to 150° C. Whereas, the pressure within the plasma nozzle is preferably between 0.01 bar abs. to 5 bar abs., more preferably 0.3 bar abs. to 2 bar abs., most preferably 0.8 bar abs. to 1.5 bar abs. The volume of the plasma-generating zone is preferably between 2⁻⁶×10⁻⁶ m³/kW and 10×10⁻⁶ m³/kW, more preferably 4×10⁻⁶ m³/kW-10×10⁻⁶ m³/kW, most preferably 6×10⁻⁶ m³/kW-10×10⁻⁶ m³/kW. Whereas, the average residence time within the plasma nozzle may be 10⁻⁶ seconds to 10⁻¹ seconds depending upon the material being ionised.

As an example, the specific energy consumed to completely crack methane passing through the microwave plasma generator of the present invention at 100% efficiency is around 23 kJ/mol.

Whist the volume of the reactor chamber will in each case be dependent upon the intended application and the processing requirements of the plasma reactor, in the case of a 2.45 GHz microwave plasma generator exemplary ranges of volumes are 10⁻³ m³ to 10³ m³, more preferably 10⁻² m³ to 10² m³, most preferably 1.5 m³ to 10² m³. However, the volume of the reaction chamber is preferably no less than 5×0⁻⁴ m³ per nozzle per KW but may extend upwards from this without limitation.

Furthermore, the residency time within the reaction chamber is dependent upon the reaction(s) occurring within the chamber and the desired output product but may extend from 0.1 seconds to several hours.

The arrangement shown in FIG. 4 represents an improved plasma generator powered by two small magnetrons. The two magnetrons (not shown) are arranged to feed a common quartz tube 404 without interfering with each other or requiring elaborate phase and frequency locking systems. Each plasma nozzle of the reactor shown in FIG. 1 may be of this type, in which case the reactor is capable of generating more significantly more power than a reactor employing plasma nozzles of the type shown in FIG. 3.

In FIG. 4, two waveguides 405 and 406 are designed to taper such that the E-field intensifies in the region of the common quartz tube 404. Gas to be processed passes through the quartz tube 404 from the manifold 104 in direction indicated by arrow 402 towards the reaction chamber 102. The gas first passes through a plasma-generating zone produced by waveguide 406 and then through a plasma-generating zone formed by the magnetron waveguide 405. It is preferable for the two plasma-generating zones to be in close proximity so that a single plasma cloud extending between the two plasma generating zones is formed, which is not to say that the waveguides 405, 406 must be antiparallel, as shown in FIG. 4. This orientation is shown for clarity only. With this arrangement, the intensity and the envelope (length) of generated plasma may be increased.

As stated previously, other designs of plasma generator are known in the art and are also suitable for use with this invention. Commercial scale production however is likely to require a high throughput of feed gases and, as such, a plasma generator operating at or above atmospheric pressure is preferred. Microwaves are particularly effective generators of atmospheric plasma for fuel gas processing.

With reference to FIG. 5, there is shown a first design of flow inducer in the form of a swirl inducer that is incorporated in the plasma nozzle 105 before the plasma-generating zone. If used in combination with the generators shown in FIGS. 3 and 4, the swirl inducer is located in the quartz tube 303, 404 upstream of the plasma-generating zone. The purpose of the swirl inducer is to agitate the feed gas into a stabilising flow such as a vortex flow as it passes through the plasma zone. The swirl inducer includes a number of slits 502 in a protrusion 501. A coupling flange 503, which may be externally cooled, allows for a flexible seal such that the quartz tube 303, 404 is not damaged as it shrinks and remains sealed as it expands, because temperature fluctuations are common during the plasma-generating process. Gas is driven under pressure into the protrusion 501 and forced to exit at the slits 502, which induces a generally helical flow pattern. The seal 503 prevents back flow to the manifold.

An alternative swirl inducer 110 is shown in FIG. 6. This is based on a small version of a Hilsch tube, which is known to induce strong vortex motion in gas flow. Compressed gas is fed in tangentially to a larger diameter tube 600 along arms 601a, b, c, d. Gas exits in a vortex flow both from the larger diameter tube 600 and an adjoining smaller diameter tube 602. Gas from the smaller tube 602 has the stronger vortex flow and is then fed to the plasma-generating zone. Gas exiting the larger tube 600 is re-circulated.

Alternative designs of flow inducers are also envisaged, for example a spiral impeller, a Vortex tube arrangement or a simple fan arrangement. All that is important is that the feed gas is induced into a stabilizing flow before passing through the plasma-generating zone of the nozzle. The purpose is two-fold. First, to stabilise the plasma within the quartz tube 303, 404 and so to ensure that it persists into the reaction chamber. Secondly, to ensure that all feed gas passes through the plasma-generating region, which improves the uniformity of its processing.

It can be seen from the above description that many useful applications of a plasma reactor in accordance with this invention exist or may be developed, many of which may be enhanced by exploitation of the ability of this chamber to support a particulate belt. In particular, embodiments of the invention may be used to dissociate feed gases such as methane, natural gas and biogas with an efficiency not previously known. The dissociated products may be recombined so as to form clean fuels such as hydrogen gas and valued by-products such as high quality carbon black.

A test was conducted using a plasma reactor comprising a single 35 mm diameter plasma nozzle connected radially to a 500 mm diameter reaction chamber at an angle of 20° to the tangent of the reaction chamber. An electrical input of 6.15 kW was supplied to the magnetron of the plasma nozzle through which methane was fed at a rate of 12.8 l/min, at a temperature of 10° C. and a pressure of 20 psig. This produced 1.6×10⁻⁵ m³ volume of plasma, equivalent to the cracking of 1 m³ of methane. Output from the reaction chamber was a quantity of hydrogen and 250 g of carbon which fell under gravity and was collected via a lower port in the reaction chamber.

The invention is adaptable to many scales of operation. Small scale operation lends itself to distributed fuel supplies such as hydrogen filling stations for future transport systems based upon hydrogen as a fuel. Alternatively, the invention could provide small domestic-scale systems that integrate with fuel cells to produce clean, environmentally-sound electricity and water. Large-scale operation lends itself to centralised clean hydrogen production systems.

An example of a small scale plasma reactor is illustrated in FIG. 7 in which the reaction chamber is supplied by a single nozzle 705. The reactor 700 comprises an inlet 703 to which feed material is supplied which flows from the inlet 703 to a feed tube consisting of a quartz tube 303 and a swirl chamber 712 and thereafter the end of the feed tube remote from the inlet 703 is in communication with a reaction chamber 702. Within the quartz tube 303 of the plasma nozzle 705 the feed material is excited by means of a magnetron 301 to form a plasma.

The plasma is stabilised through controlled motion of the ionised particles so that the plasma afterglow persists and is able to flow through the nozzle 705 into the reaction chamber 702 where it remains reactive for a time. To achieve the necessary controlled stabilising motion, the nozzle 705 includes a swirl inducer (described above) which is located upstream of the region where the plasma is formed so that vortex motion is induced in the feed material and this motion persists in the plasma.

A lower chamber 708 is located below the reaction chamber 702 and this may be used in separating reaction products such as solid products of the reaction taking place within the reaction chamber 702 which are collected in the lower chamber 708 and which pass through a gas restricting valve 706, for example a rotary valve, to a lower output port 707. An upper output port 701 is provided in the chamber 702 which is used to collect gaseous reaction products.

As can be seen in FIG. 7, the output of the nozzle 705 is in communication with the top of the reaction chamber 702 (rather than the side as illustrated in the preceding embodiments) so that plasma generated within the nozzle is supplied through an aperture in the top of the reaction chamber 702. The nozzle 705 and the aperture in the top of reaction chamber are arranged coaxially with the chamber 702 so that the vortex motion of the plasma developed within the nozzle is communicated to and continues within the reaction chamber 702.

As mentioned earlier, the plasma passes through a swirl chamber 712 along its path to the reaction chamber. The preferred structure of the swirl chamber 712 is designed to encourage and sustain the plasma stabilising flow. Hence, the swirl chamber 712 is frusto-conical in shape and tapers inwardly towards its connection to the reaction chamber. Moreover, the swirl chamber includes an inlet port 711 in the tapering wall of the swirl chamber through which solid or fluid reactants are introduced. The inlet port 711 is arranged so that the kinetic energy of the reactants introduced through the inlet port 711 contributes to and further sustains the vortex motion of the plasma.

An example of an application of the plasma reactor in accordance with this embodiment is in the dissociation of methane to carbon and hydrogen, the carbon being used to form nanostructures. Seed material comprising carbon and iron oxide is injected through the aperture at the nozzle outlet and is guided by the flow within the chamber to form a suspended belt.

Carbon is deposited on the iron oxide, which acts as a substrate for the carbon. Although the carbon and iron oxide may be injected along with the methane, it is also envisaged that the particulates may be injected via their own inlet port directly into the reaction chamber and/or may be injected using inactive nozzles.

Still further applications include the processing of toxic and hazardous waste materials, recovering valued elements while destroying the dangerous feed material.

Various configurations of gas inputs and outputs are possible, depending on the nature of the process required. Input channel 103 may be fed with the gas to be processed, cleaned or polished. In other processes, this gas is fed through input port 152 and is therefore not dissociated to form a plasma. The plasma may be formed using an inert buffer gas or other reactive gas. Processed gas collected at the output port 151 may be re-fed to the chamber via input channel 103 or input port 152, depending on the process being carried out. This allows multiple cycles of cleaning or processing until the processed gas is reduced to an acceptable level of impurities/hazard/contamination.

The removal of sulphur dioxide (SO₂) from flue gas is an example of a gas cleaning process that may be performed using the plasma reactor of FIG. 7. In overview the process which enables the sulphur dioxide to be removed is as follows:

2SO₂+2H₂O+O₂>2H₂SO₄

Within the plasma reactor described above the dissociation of water and oxygen into a plasma forms hydroxyl radicals and oxygen atoms:

(O₂+e)+(2H₂O+e)>OH+OH+OH+O+O+O+O

The hydroxyl radicals and oxygen atoms then react with the sulphur dioxide to form sulphuric acid which may then be extracted from the flue gas. In this way the gas cleaning process may be performed continuously and without interruption with new flue gas constantly being injected into the reaction chamber via the one or more nozzles.

Although the plasma reactor has been described principally in relation to the use of microwave plasma-generating sources It is envisaged that the present invention may employ alternative types of plasma sources and also that a multiplicity of different types of plasma sources may be connected to a single reaction chamber. An example, of a non-microwave plasma source is as follows: three electrodes arranged in a plane such that they are equidistant from each other with a plasma-generating zone lying in the plane of the three electrodes and equidistant therefrom. An electrically insulated tube of a suitable inert material, such as a ceramic, is arranged along an axis at 90 degrees to the plane of the three electrodes and intersecting that plane. The tube is used to contain a gas flow that flows across the plasma-generating zone. A high voltage DC, AC (which may be 3 phase supply) or pulsed DC is applied to the electrodes such that an arc is discharged between the electrodes passing through apertures in the tube and thus across the plasma-generating zone. The arc ionises the gas flowing across the plasma-generating zone between the electrodes, producing a plasma. The voltage applied to the electrodes must exceed the breakdown voltage of the gas flowing between the electrodes and the current may be limited by current control circuitry such that the power transferred into the plasma is controlled according to the desired reaction.

When the supply is either AC or DC the plasma is predominantly thermal, however when pulsed DC is used, a degree of non-equilibrium plasma is also produced. It will, of course, be apparent that the plasma generated may be stabilized using the same or similar techniques to those described above.

Changes to the plasma reactor other than those described above are envisaged without departing from the spirit and scope of the invention as defined in the claims appended hereto. Furthermore, it will be immediately apparent that processes other than those described above may additionally be performed using the plasma reactor of this invention.

1-44. (canceled)

45. A reaction vessel comprising:
a reaction chamber; and
one or more plasma sources coupled to the reaction chamber, wherein each plasma source comprises:
a plasma generator in fluid communication with a reaction region within the reaction chamber whereby the plasma generator at least partly ionises material to form a plasma prior to entry of the at least partly ionised material into the reaction region,
wherein the reaction vessel further includes a flow inducer for establishing a fluid flow within the reaction chamber,
wherein the flow inducer comprises the coupling of the one or more plasma sources to the reaction chamber, the coupling being adapted to induce the flow of the at least partly ionised material from the plasma generator to establish a fluid flow within the reaction chamber,
wherein the flow of the at least partly ionised material from the plasma generator is a vortex, and
particulate material is supplied to the reaction chamber via at least one of the plasma nozzles either before or after the plasma source and the fluid flow within the reaction chamber holds the particulate material within the reaction region in suspension.

46. The reaction vessel according to claim 45, wherein
wherein the flow inducer is separate from the one or more plasma sources, and wherein the flow inducer comprises an agitating element within the reaction chamber.

47. The reaction vessel according to claim 46, wherein the flow inducer comprises a pressure management device for establishing a differential pressure between the one or more plasma sources and the reaction chamber.

48. The reaction vessel according to claim 45, wherein
wherein the reaction chamber includes an upper outlet at or near the top of the reaction chamber for the extraction of gaseous material, and
wherein the upper outlet has an exit channel that extends through the wall of the chamber and extends into the reaction chamber a predetermined or an adjustable length.

49. The reaction vessel according to claim 48, wherein the particulate material is either carbon or an inorganic oxide.

50. The reaction vessel according to claim 45, wherein the reaction chamber includes at least one outlet separated spatially from the plasma-generating zone, the at least one outlet and the fluid flow in the reaction chamber being arranged so as to enable removal of a reaction product from the reaction chamber without interrupting plasma generation.

51. The reaction vessel according claim 45, wherein at least one of the one or more plasma sources has a feed tube extending at least from the plasma generator to the coupling of the plasma source to the reaction chamber, the feed tube being adapted to encourage a plasma stabilising flow within the feed tube.

52. The reaction vessel according to claim 51, wherein the plasma stabilising flow is a vortex.

53. The reaction vessel according to claim 51, wherein the feed tube tapers inwardly towards the coupling of the plasma source with the reaction chamber.

54. The reaction vessel according to claim 53, wherein the feed tube is coaxially aligned with the reaction chamber whereby the plasma stabilising flow in the feed tube contributes to a stabilising fluid flow within the reaction chamber.

55. The reaction vessel according to any of claim 45. wherein the plasma generator of one or more of the plasma sources is a microwave plasma generator.

56. The reaction vessel according to claim 55, wherein the plasma generator of one or more of the plasma sources is a plasma nozzle having a magnetron as a microwave plasma generating source, where each nozzle comprises a feed tube through which feed materials flow and each magnetron may comprise at least one waveguide dimensioned for microwave radiation and arranged to intersect the feed tube at or near a position at which the electric field of the microwave radiation is most intense.

57. The reaction vessel according to claim 55, wherein the reaction chamber is non-resonant with respect to the plasma generator.

58. The reaction vessel according to claim 55 further comprising:
a secondary chamber in fluid communication with the reaction chamber,
wherein the secondary chamber includes an exit port which is fitted with a gas-restricting valve.

59. The reaction vessel according to claim 58, wherein the secondary chamber includes an electrostatic collector, powder precipitator or polymer-forming substrate.

60. The reaction vessel according to of claim 45, wherein the vessel includes an atomising or vaporising device for atomising or vaporising one or more reactants and/or the material to be ionised.

61. A plasma nozzle comprising:
a plasma generator;
a feed tube for directing a flow of feed material from an inlet past a plasma-generating zone to a nozzle outlet remote from the plasma generator, the nozzle outlet being adapted to couple to a reaction chamber; and
flow management means for controlling the flow of feed material in the feed tube whereby the plasma generator at least partly ionises the feed material to form a plasma which is sustained by the flow to the nozzle outlet,
wherein the nozzle includes two plasma generators, each with a respective plasma-generating zone, arranged such that the feed tube intersects both plasma-generating zones.

62. The plasma nozzle according to claim 61,
wherein the spacing between the respective intersections of the two plasma-generating zones with the feed tube is selected so that a single plasma cloud is formed within the feed tube extending between the two intersections.

63. The hydrogen generating vessel comprising:
a supply connection adapted to connect to a supply of a gaseous hydrocarbon; and
one or more plasma sources coupled thereto and a reaction chamber coupled to the one or more plasma sources;
wherein each of the plasma sources has a plasma generator and is adapted to direct a flow of the hydrocarbon via the plasma generator to a reaction region within the reaction chamber whereby the plasma generator at least partly ionises the gaseous hydrocarbon to form a plasma prior to entry of the at least partly ionised hydrocarbon into the reaction region and
wherein the reaction chamber includes at least one outlet via which hydrogen is collected, and
wherein the one or more plasma sources are plasma nozzles each comprising a microwave plasma generator.

64. A carbon extraction vessel comprising:
a supply connection adapted for connection to a supply of a gaseous hydrocarbon; and
one or more plasma sources coupled thereto and a reaction chamber coupled to the one or more plasma sources;
wherein each of the plasma sources has a plasma generator and is adapted to direct a flow of the hydrocarbon via the plasma generator to a reaction region within the reaction chamber whereby the plasma generator at least partly ionises the gaseous hydrocarbon to form a plasma prior to entry of the at least partly ionised hydrocarbon into the reaction region, and
wherein the reaction chamber includes a particulate suspension that acts as a substrate onto which carbon is preferentially deposited.
